(19) United States
(12) Patent Application Publication
(10) Pub. No.: US 2007/0048609 A1
(43) Pub. Date: Mar. 1, 2007

(54) Negative electrode for non-aqueous electrolyte secondary battery, producing method therefor, and non-aqueous electrolyte secondary battery

(76) Inventors: Tomohiro Ueda, Nara (JP); Tetsuo Nanno, Osaka (JP); Yasuhiko Bito, Osaka (JP)

Correspondence Address: MCDERMOTT WILL & EMERY LLP, 600 13TH STREET, NW, WASHINGTON, DC, 20005-3096, US

(21) Appl. No.: 11/510,668

(22) Filed: Aug. 28, 2006

(30) Foreign Application Priority Data
Aug. 29, 2005 (JP) 2005-247115

(51) Int. Cl. H01M 4/58; H01M 4/62

(52) U.S. Cl. 429/218.1; 429/217; 429/231.5; 429/223; 429/220; 429/221; 252/182.1

(57) ABSTRACT

A negative electrode for a non-aqueous electrolyte secondary battery in the present invention includes an active material including Si, a conductive material, and a binder. The binder is polyimide and polyacrylic acid, and the conductive material is a carbon material.

### BACKGROUND OF THE INVENTION

The present invention relates to non-aqueous electrolyte secondary batteries, particularly to an improvement in negative electrodes for non-aqueous electrolyte secondary batteries.

Non-aqueous electrolyte batteries are small and lightweight, have high energy density, and are used as a main power source for various electronic devices and as a power source for memory backup. Nowadays, with remarkable advancement of portable electronic devices involving further downsizing, higher performance, and less maintenance, a further high energy density is desired in non-aqueous electrolyte batteries.

Many examinations have been carried out for positive electrode active materials and negative electrode active materials, since battery characteristics are highly dependent on characteristics of positive electrode active materials and negative electrode active materials.

For example, Si is capable of producing an intermetallic compound with Li and of reversively absorbing and desorbing Li. When Si is used for the negative electrode active material, the theoretical capacity of Si is about 4200 mAh/g, i.e., quite large compared with the theoretical capacity of conventionally used carbon materials, which is about 370 mAh/g. Thus, many examinations have been carried out for an improvement in the use of Si for the negative electrode active material, aiming for battery downsizing and a higher capacity.

However, Si particles are prone to crack and be micronized by changes in volume thereof involved with absorption and desorption of Li. Thus, despite the high capacity, the negative electrode active material including Si is disadvantageous in that the capacity is greatly reduced by going through charge and discharge cycles and that a cycle life is shortened.

For such disadvantages, for example, Japanese Laid-Open Patent Publication No. 2004-335272 has proposed a usage of a negative electrode active material comprising a phase A mainly composed of Si and a phase B including a silicide of a transition metal, wherein at least one of the phase A and the phase B is in at least one state of amorphous state and low crystalline state. The usage of such negative electrode active material reduces the volume change involved with absorption and desorption of Li, and improves the cycle life.

Positive electrodes and negative electrodes are composed of a mixture including an active material contributing to the charge and discharge reaction, a conductive material, and a binder. The conductive material is used for an improvement in electron conductivity between the active material particles. The binder is used for binding the electrode materials in the mixture such as active material particles and a conductive material, and bonding the mixture with the current collector.

For the binder, fluorocarbon resin such as polytetrafluoroethylene (PTFE) and polyvinylidene fluoride (PVDF) are used. Such fluorocarbon resin are stable for non-aqueous electrolytes, and are excellent in binding the active material and the conductive material.

However, when Si or Sn is used for the active material, even though the above fluorocarbon resin are used as a binder, it is difficult to maintain good binding conditions of the mixture due to volume changes in the above active material involved with absorption and desorption of Li during charge and discharge. The bonding ability between the mixture and the current collector is easily reduced as well. Therefore, current collecting ability of the mixture is reduced with charging and discharging, decreasing utilization rate of the active material, and greatly increasing deterioration involved with charge and discharge cycles.

It is known that usage of polyimide as a binder improves binding ability for the electrode materials in the mixture, and binding ability between the mixture and the current collector, and enables excellent charge and discharge cycle characteristics without separation of the mixture from the current collector even when an active material with a greater volume change during charge and discharge is used.

For example, Japanese Laid-Open Patent Publication No. 2004-288520 has proposed the following, aiming for an improvement in cycle characteristics. In a negative electrode for secondary batteries, polyimide is used as a binder, in a mixture layer including an active material comprising at least one of silicon and a silicon alloy, or between the mixture layer and a metal foil current collector. A conductive intermediate layer is disposed on the metal foil current collector and sintered under a non-oxidizing atmosphere. The conductive intermediate layer inhibits the separation of the mixture layer from the current collector due to expansion and contraction of the negative electrode active material involved with charge and discharge reaction, and this intermediate layer increases the binding ability between the mixture layer and the current collector.

In manufacturing mobile devices, in many cases, electronic components are mounted on printed circuit boards by reflow soldering, which enables dense and collective soldering of the electronic components.

The reflow soldering is a method as described below. A solder cream is applied on a portion of a printed circuit board where soldering is to be carried out. Afterwards, the printed circuit board with electronic components mounted are allowed to pass through a high temperature furnace set to produce a temperature of 200 to 260° C. at the soldering portion. The solder is then melted to be soldered.

Thus, when a non-aqueous electrolyte secondary battery is to be set on a printed circuit board for memory backup and the above reflow soldering is to be used, the battery itself needs to have heat resistance. For such a concern, there has been examined a usage of heat-resistive materials for battery components such as electrolytes, separators, and gaskets.

Binders for non-aqueous electrolyte secondary batteries excellent in heat resistance include, for example, polyimide (melting point: about 500° C.). Polyimide is highly heat-stable, and has excellent heat resistance compared with other organic polymer materials.

However, when polyimide is used for a binder of a negative electrode of a non-aqueous electrolyte secondary battery, the battery's low temperature characteristics easily deteriorate.

Japanese Laid-Open Patent Publication No. Hei 9-265990 has proposed the following. A carbon material is used for a negative electrode active material of a non-aqueous electrolyte battery. A polyimide resin as a binder is mixed with an acrylic acid polymer, a methacrylic acid polymer, and a urethane polymer as binding auxiliaries, and afterwards, the binding auxiliaries are decomposed and removed by a heat treatment. This improves cycle characteristics.

However, since the binding auxiliaries are decomposed and removed by the heat treatment and only polyimide functions as the binder, the low temperature characteristics decline as in the above case.

Further, Japanese Laid-Open Patent Publication No. Hei 10-188992 has proposed, a usage of a mixture of polyimide and a fluoropolymer as a binder. Polyimide completed the imidization is soluble to organic solvents. This improves productivity because the imidization by a high temperature heat treatment becomes unnecessary.

However, the above binder soluble to organic solvents dissolves in an organic electrolyte of a non-aqueous electrolyte secondary battery, and it is difficult to retain the binder function, leading to a decline in cycle characteristics and storage characteristics. Additionally, without the high temperature heat treatment, water produced upon dehydrating condensation by the imidization remains and may give adverse effects on the positive electrode active material.

The present invention aims to provide a negative electrode excellent in binding ability even though the active material includes Si, and excellent in electron conductivity even though polyimide is used in the binder, and aims to provide a manufacturing method for the negative electrode. Additionally, the present invention aims to provide a high energy density non-aqueous electrolyte battery with excellent charge and discharge cycle characteristics, low temperature characteristics, and heat resistance by using the above negative electrode.

### BRIEF SUMMARY OF THE INVENTION

The present invention relates to a negative electrode for a non-aqueous electrolyte secondary battery, the electrode comprising an active material including Si, a binder, and a conductive material. The binder comprises polyimide and polyacrylic acid, and the conductive material comprises a carbon material.

The present invention also relates to a non-aqueous electrolyte secondary battery comprising the above negative electrode, a positive electrode, a separator interposed between the positive electrode and the negative electrode, and a non-aqueous electrolyte.

Further, the present invention relates to a method of producing a negative electrode, the method comprising the steps of:

(1) mixing an active material including Si, a binder material solution including polyamic acid and polyacrylic acid, and a carbon material as a conductive material, and

heating and drying the mixture to obtain a negative electrode mixture; and

(2) pressure-molding the negative electrode mixture to obtain pellets, and

heating the pellet to imidize polyamic acid to obtain polyimide, thereby obtaining a negative electrode including polyimide and polyacrylic acid as a binder.

According to the present invention, since polyacrylic acid takes precedence in making bond with the negative electrode active material including Si to retard the intense coverage of the negative electrode active material by polyimide, excellent electron conductivity can be obtained, along with excellent binding ability and heat resistance. Also, according to the present invention, by using the above negative electrode, a high energy density non-aqueous electrolyte secondary battery excellent in charge and discharge cycle characteristics, low temperature characteristics, and heat resistance can be obtained.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWINGS

FIG. 1 is a vertical cross section of an example of a non-aqueous electrolyte secondary battery of the present invention.

### DETAILED DESCRIPTION OF THE INVENTION

The present invention relates to a negative electrode for a non-aqueous electrolyte secondary battery. The negative electrode comprises a negative electrode active material including Si, a binder, and a conductive material. The binder comprises polyimide and polyacrylic acid, and the conductive material is a carbon material.

Conventionally, when polyimide alone is used for the binder, although polyimide's excellency in heat resistance and binding ability improves cycle characteristics of batteries, low temperature characteristics of the batteries decline. This is probably due to the fact that the negative electrode active material particles including Si are widely covered by polyimide and the contacts between the negative electrode active material particles and the carbon material, i.e., the conductive material, are prevented to decline the electron conductivity of the negative electrode.

When polyacrylic acid alone is used for the binder, unlike the case with polyimide, the low temperature characteristics of batteries do not decline due to weak binding ability and low heat resistance of polyacrylic acid compared with polyimide, but cycle characteristics and heat resistance of batteries decline.

On the other hand, when a mixture of polyimide and polyacrylic acid is used for the binder of the negative electrode, as in the present invention, polyacrylic acid precedes the polyamide in bonding with the negative electrode active material particles including Si, retarding the coverage of the negative electrode active material particles by the polyamide. This improves the electron conductivity of the negative electrode, and retard the decline in battery low temperature characteristics caused when polyimide alone is used as the binder. Additionally, by using both polyimide and polyacrylic acid for the binder, due to the excellent binding ability of polyimide, cycle characteristics equivalent to the case when polyimide alone is used for the binder can be achieved.

Thus, use of such negative electrode as noted in the above enables a high energy density non-aqueous electrolyte secondary battery excellent in charge and discharge cycle characteristics, low temperature characteristics, and heat resistance.

The polyacrylic acid content in the negative electrode is preferably 0.5 to 30 parts by weight per 100 parts by weight of the negative electrode active material.

The polyimide content in the negative electrode is preferably 6.5 to 40 parts by weight per 100 parts by weight of the negative electrode active material.

The weight ratio of polyacrylic acid and polyimide included in the negative electrode is preferably 5 to 90:9 to 95.

The negative electrode active material including Si capable of being alloyed with lithium includes, for example, silicon itself, a silicon oxide, and a silicon alloy. For the silicon oxide, for example, SiOₓ (0<x<2, preferably 0.1≦x≦1) may be used. For the silicon alloy, for example, an alloy including Si and a transition metal M (M—Si alloy) may be used. For example, a Ni—Si alloy and a Ti—Si alloy are used preferably. The negative electrode active material including Si may be any of single crystal, polycrystal, and amorphous.

The negative electrode active material preferably comprises a first phase (phase A) mainly containing Si, and a second phase (phase B) containing a silicide of a transition metal, and at least one of the first phase and the second phase is in at least one state of amorphous state and low-crystalline state. This enables obtaining a non-aqueous electrolyte secondary battery with high capacity and excellent cycle life. The phase B preferably includes a transition metal and a silicide.

The phase A contributes to absorbing and desorbing of Li. That is, the phase A is capable of electrochemical reaction with Li. The phase A is preferably a single phase of Si, in view of a large absorption and desorption amount of Li per weight or volume of the phase A. However, since Si is poor in electron conductivity, an element such as phosphorus, boron, or a transition metal, may be added in the phase A, to improve the electron conductivity of the phase A.

The phase B including a silicide is highly compatible with the phase A, and particularly, cracks at crystal interface between the phase A and the phase B are hardly caused even at the time of volume expansion while charging. The phase B is high in electron conductivity and hardness compared with the phase A mainly composed of Si. Thus, by including the phase B in the active material, the low electron conductivity due to the phase A is improved, and the stress at the time of expansion is modified, thereby retarding the cracks of the active material particles.

The phase B may comprises a plurality of phases. For example, the phase B may comprise two phases each having a different compositional ratio of a transition metal M and silicon, such as MSi₂ and MSi (M is a transition metal). The phase B may also be composed of, for example, three or more phases including the above two phases and a phase including a silicide of a different transition metal. The transition metal M is preferably at least one selected from the group consisting of Ti, Zr, Ni, Cu, Fe, and Mo. The above silicide of a transition metal M has a high degree of electron conductivity and strength. Among these transition metals, Ti is further preferable as the transition metal M. The phase B preferably includes TiSi₂.

When the negative electrode active material particles including Si contain a transition metal, the transition metal at the surfaces of negative electrode active material particles is oxidized to form an oxide of the transition metal at the surfaces of the negative electrode active material particles. Since a hydroxyl group (—OH) exists at the transition metal oxide surface, the bond between the negative electrode active material and polyacrylic acid becomes stronger, and polyacrylic acid takes precedence in bonding with the negative electrode active material, thereby retarding the decline in the low temperature characteristics of the battery even when polyimide is used as the binder.

For the carbon material in the negative electrode, graphite and carbon black are used, for example. Although not particularly limited, the carbon material content in the negative electrode is preferably 1.0 to 50 parts by weight per 100 parts by weight of the negative electrode active material, and further preferably 1.0 to 40 parts by weight per 100 parts by weight of the negative electrode active material.

A manufacturing method for a negative electrode of the present invention includes step (1) and step (2). In step (1), an active material including Si, a binder material solution including polyamic acid and polyacrylic acid, and a carbon material as a conductive material are mixed, and the mixture is heated and dried to obtain a negative electrode mixture. In step (2), the negative electrode mixture is pressure-molded to obtain a pellet, and the pellet is heated to imidize polyamic acid to obtain polyimide, thereby obtaining a negative electrode including polyimide and polyacrylic acid as the binder.

For the binder material solution, for example, an N-methyl-2-pyrrolidone (NMP) solution including polyamic acid and polyacrylic acid is used. In the binder material solution, although polyimide may be used directly instead of polyamic acid, polyimide is hardly soluble in a solvent such as NMP and hardly dispersed homogenously in the negative electrode mixture. On the other hand, in the above binder material solution, polyamic acid, which is a precursor of polyimide is easily dissolved in a solvent such as NMP. Thus, polyamic acid can be dispersed in the negative electrode mixture homogenously, and by imidizing polyamic acid, polyimde can be dispersed homogenously in the negative electrode. In step (1), for example, the negative electrode mixture is heated and dried at 60° C. for 12 hours under vacuum. Since the heating temperature in step (1) is sufficiently lower than the heating temperature for an imidization reaction to be mentioned later, in step (1), the imidization reaction does not occur.

The heating process in step (2) causes the imidization (dehydration polymerization) of polyamic acid, and polyimide is obtained. Polyimide and polyacrylic acid function as the binder of the negative electrode. For the heating process, a hot blast, an infrared radiation, a far-infrared radiation, and an electron beam are used singly or in combination.

The heating temperature of the pellets is preferably 200 to 300° C., and further preferably 200 to 250° C. When the pellets are subjected to the heating process with a temperature of 200 to 300° C., the imidization of polyamic acid sufficiently advances, and the amount of polyacrylic acid added at the time of manufacturing the negative electrode can be left in the negative electrode without decomposing polyacrylic acid. The imidization reaction in step (2) easily advances at a temperature of 200° C. or more. When the heating temperature exceeds 300° C., polyacrylic acid easily decomposes. When the amount of polyacrylic acid remained in the negative electrode became less, the effect that polyacrylic acid takes precedence in bonding with the negative electrode active material including Si and retards the negative electrode active material surface coverage by polyimide decrease, thereby decreasing the electron conductivity of the negative electrode, and failing to achieve sufficiently the effects of improving the battery low temperature characteristics. Although the dehydration polymerization by the imidization generates water, the water is removed because the pellet is heated at a temperature of 200 to 300° C. Thus, water will not go inside of the battery system.

The imidization rate of polyamic acid is preferably 80% or more. When the imidization reaction of polyamic acid is below 80%, polyimide does not function as a binder sufficiently, and the cycle characteristics easily decline. The imidization rate of the polyamic acid can be controlled, for example, by adjusting the heating temperature and time for the pellets in step (2). The imidization rate can be obtained by the infrared spectroscopy (IR).

The appropriate binder content in the negative electrode mixture is, in view of battery characteristic, the minimum amount that sufficiently maintain the binding ability between the negative electrode active material particles. In view of this, the total of the polyamic acid content and polyacrylic acid content in the negative electrode mixture is preferably 0.5 to 30 parts by weight per 100 parts by weight of the negative electrode active material. When the total of the polyamic acid content and the polyacrylic acid content in the negative electrode mixture is below 0.5 parts by weight per 100 parts by weight of the negative electrode active material, the effects as a binder become insufficient. On the other hand, when the total of the polyamic acid content and the polyacrylic acid content in the negative electrode mixture is over 30.0 parts by weight per 100 parts by weight of the negative electrode active material, the binder amount will be excessive and the active material amount decreases relatively, thereby decreasing the battery capacity.

The polyamic acid content in the negative electrode mixture is preferably 10 to 95 parts by weight per 100 parts by weight of the total of polyamic acid and polyacrylic acid, in view of obtaining excellent cycle characteristics and low temperature characteristics. When the polyamic acid content in the negative electrode mixture is below 10.0 parts by weight per 100 parts by weight of the total of polyamic acid and polyacrylic acid, the amount of polyimide to be obtained will be less, and the cycle characteristics decline. When the polyacrylic acid content in the negative electrode mixture exceeds 95 parts by weight per 100 parts by weight of the total of polyamic acid and polyacrylic acid, the amount of polyacrylic acid capable of taking precedence in bonding with the negative electrode active material becomes insufficient, and polyimide covers the negative electrode active material strongly, making the battery low temperature characteristics tend to decline.

The non-aqueous electrolyte secondary battery of the present invention comprises the above negative electrode, a positive electrode, a separator disposed between the positive electrode and the negative electrode, and a non-aqueous electrolyte. Use of the above negative electrode enables obtaining a high energy density non-aqueous electrolyte secondary battery excellent in charge and discharge cycle characteristics, low temperature characteristics, and heat resistance. Shape and size of the non-aqueous electrolyte secondary battery are not limited particularly. The negative electrode of the present invention may be applied to non-aqueous electrolyte secondary batteries of various forms, such as cylindrical and rectangular. Also, since the non-aqueous electrolyte secondary battery of the present invention does not use a material including fluorine for a binder as in the above, battery deterioration is not caused by a reaction of hydrogen fluoride, which is generated by the thermal decomposition of the binder including fluorine, with the negative electrode active material.

The positive electrode comprises, for example, a positive electrode mixture including a positive electrode active material, a binder, and a conductive material.

For the positive electrode active material, a lithium-containing compound or a lithium-non-containing compound capable of absorbing and desorbing lithium ion is used. For example, LiₓCoO₂, LiₓNiO₂, LiₓMnO₂, LiₓMn_{1+y}O₄, LiₓCo_{y}Ni_{1-y}O₂, LiₓCo_{y}M_{1-y}O_{z}, LiₓNi_{1-y}M_{y}O_{z}, LiₓMn₂O₄ and LiₓMn_{2-y}M_{y}O₄ (M is at least one selected from the group consisting of Na, Mg, Sc, Y, Mn, Fe, Co, Ni, Cu, Zn, Al, Cr, Pb, Sb, and B) may be mentioned. In the above, x is 0 to 1.2, y is 0 to 0.9, and z is 2.0 to 2.3. The value of x changes during charge and discharge. A chalcogenized compound containing transition metal, a vanadium oxide and a lithium compound thereof; a niobium oxide and a lithium compound thereof; a conjugated polymer using an organic conductive material; and a Chevrel phase compound may also be used. The above compounds may be used singly or in combination.

A binder and a conductive material for the positive electrode are not particularly limited, as long as the one that can be used for non-aqueous electrolyte secondary batteries.

For the separator, for example, a microporous film with excellent ionic permeability is used. For example, a glass fiber sheet, a nonwoven fabric, and a woven fabric are used.

Also, in view of resistance to an organic solvent and hydrophobicity, for the separator material, polypropylene, polyethylene, polyphenylene sulfide, polyethylene terephthalate, polyamide, and polyimide are used. These may be used singly or in combination. Although low-cost polypropylene is used usually, when reflow resistance is to be added to batteries, polypropylene sulfide, polyethyleneterephthalate, polyamide, and polyimide having a heat distortion temperature of 230° C. or more are used preferably among these.

The thickness of the separator is, for example, 10 to 300 μm. Although the porosity of the separator is decided according to electron and ion permeability, and separator material, generally, the porosity is preferably 30 to 80%.

For the non-aqueous electrolyte, for example, a non-aqueous solvent with a lithium salt dissolved therein is used.

For the non-aqueous solvent, for example, cyclic carbonates such as ethylene carbonate (EC), propylene carbonate (PC), butylene carbonate (BC), and vinylene carbonate (VC); linear carbonates such as dimethyl carbonate (DMC), diethyl carbonate (DEC), ethyl methyl carbonate (EMC), and dipropyl carbonate (DPC); aliphatic carboxylic acid esters such as methyl formate, methyl acetate, methyl propionate, and ethyl propionate; γ-lactones such as γ-butyrolactone; linear ethers such as 1,2-dimethoxyethane (DME), 1,2-diethoxyethane (DEE), and ethoxymethoxyethane (EME); cyclic ethers such as tetrahydrofuran, and 2-methyl tetrahydrofuran; aprotic organic solvents such as dimethyl sulfoxide, 1,3-dioxolane, formamide, acetamide, dimethyl formamide, dioxolane, acetonitrile, propylnitrile, nitromethane, ethyl monoglyme, phosphoric triester, trimethoxymethane, dioxolane derivative, sulfolane, methyl sulfolane, 1,3-dimethyl-2-imidazolidinone, 3-methyl-2-oxazolidinone, propylene carbonate derivative, tetrahydrofuran derivative, ethyl ether, 1,3-propanesultone, anisole, dimethyl sulfoxide, N-methylpyrrolidone, butyl diglyme, and methyl tetraglyme may be mentioned. These can be used singly or in combination.

Among the above, in view of reflow resistance, ethylene carbonate, propylene carbonate, sulfolane, butyl diglyme, methyl tetraglyme, and γ-butyrolactone with a boiling point of 200° C. or more under normal atmospheric pressure are preferably used.

For the above lithium salts, for example, LiClO₄, LiBF₄, LiPF₆, LiAlCl₄, LiSbF₆, LiSCN, LiCF₃SO₃, LiCF₃CO₂, Li(CF₃SO₂)₂, LiAsF₆, LiB₁₀Cl₁₀, lithium lower aliphatic carboxylate, LiCl, LiBr, LiI, chloroboran lithium, tetraphenyl lithium borate, LiN(CF₃SO₂)₂, and LiN(C₂F₅SO₂)₂ may be used. These may be used singly or may be used in combination. A solid electrolyte such as gel may be used. Although the concentration of the lithium salt in the non-aqueous electrolyte is not particularly limited, the concentration is preferably 0.2 to 2.0 mol/L and particularly preferably 0.5 to 1.5 mol/L.

The present invention is described in detail based on Examples below. However, the present invention is not limited to the Examples.

### EXAMPLE 1

(1) Preparation of Negative Electrode Active Material

A Ti powder (manufactured by Kojundo Chemical Lab. Co., Ltd., 99.99% purity, and particle size of below 20 μm) and a Si powder (manufactured by Kanto Chemical Co., Inc., 99.999% purity, and particle size of below 20 μm) were mixed in a weight ratio of 32.2:67.8 so that the proportion of the Si phase, i.e., the phase A in the negative electrode active material particles, is 30 wt %.

The mixed powder was placed in a vibration mill container, and further stainless steel balls (diameter of 2 cm) were placed so that the balls occupied 70 volume % of the container capacity. After vaccuming the inside of the container, the inside of the container was replaced with Ar (manufactured by Nippon Sanso Corporation, and 99.999% purity) until the pressure of the inside of the container becomes 1 atmosphere. Afterwards, mechanical alloying was carried out for 60 hours while applying a vibration of 60 Hz, to obtain a Ti—Si alloy.

As a result of carrying out an X-ray diffraction measurement for the obtained Ti—Si alloy powder, it was confirmed that a Si single phase and a TiSi₂ phase existed in the alloy particles. Also, as a result of observing the alloy material with a transmission electron microscope (TEM), the existence of a Si phase which is amorphous or having a crystal size of about 10 nm, and a TiSi₂ phase having a crystal size of about 15 to 20 nm was confirmed.

(2) Preparation of Binder Material Solution

To a polyamic acid solution (U-varnish A manufactured by Ube Industries, LTD., and 20 wt % NMP (N-methyl-2-pyrrolidone) solution), which is a precursor of polyimide, 10 wt % of a polyacrylic acid powder (JURYMER AC-10LHP manufactured by Nihon Junyaku Co., Ltd.) was dissolved to obtain a binder material solution.

(3) Preparation of Negative Electrode

The negative electrode active material, the binder material solution obtained in the above, and a graphite powder (SP-5030 manufactured by Nippon Graphite Industries, ltd.) as a conductive material were mixed. The mixture was dried at 60° C. for 12 hours under vacuum, to obtain a negative electrode mixture. The weight ratio between the Ti—Si alloy, the graphite powder, polyamic acid, and polyacrylic acid in the negative electrode mixture was 100:20:5:5.

Then, the negative electrode mixture was pressure-molded to obtain a negative electrode pellet with a diameter of 4.0 mm and a thickness of 0.3 mm in the form of disk. The negative electrode pellet was heated at 250° C. for 12 hours, for imidizing polyamic acid existed inside the pellets to obtain a negative electrode. The imidization rate at this time was 98%. The imidization rate was obtained by using the infrared spectroscopy (IR). Also, after heating, the infrared spectroscopy (IR) confirmed that the amount of polyacrylic acid added while in the preparation of the negative electrode existed in the negative electrode.

(4) Preparation of Positive Electrode

Manganese dioxide and lithium hydroxide were mixed with a mole ratio of 2:1, and then the mixture was baked at 400° C. for 12 hours in air to obtain lithium manganate. Then, 88 parts by weight of the lithium manganate powder obtained in the above as a positive electrode active material, 6 parts by weight of carbon black as a conductive material, and an aqueous dispersion in an amount including 6 parts by weight of a fluorocarbon resin as a binder were mixed. The mixture was dried at 60° C. for 12 hours under vacuum to obtain a positive electrode mixture. The positive electrode mixture was pressure-molded, to obtain a positive electrode pellet in disk form with a diameter of 4.0 mm and a thickness of 1.1 mm. The positive electrode pellet was dried at 250° C. for 12 hours to obtain a positive electrode.

(5) Preparation of Coin Batteries

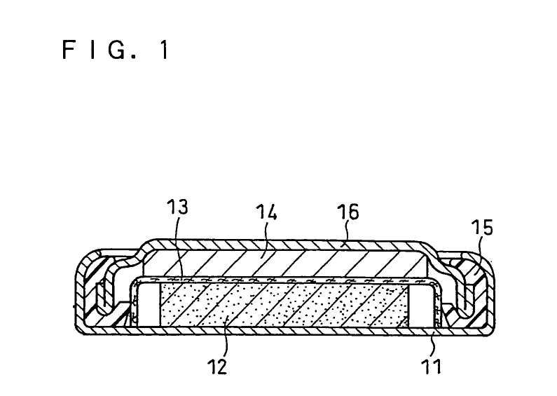

A coin battery shown in FIG. 1 was prepared by the following procedures. FIG. 1 is a vertical cross section of a coin battery of the present invention.

A positive electrode 12 obtained in the above was placed in a positive electrode can 11 comprising a stainless steel, and a separator 13 comprising a porous polyethylene sheet was placed on the positive electrode 12. An electrolyte was injected into the positive electrode can 11. For the electrolyte, an organic solvent including 1 mol/L of LiN(CF₃SO₂)₂ as a lithium salt was used. For the organic solvent, a solvent mixture of PC, EC, and DME (volume ratio PC:EC:DME=1:1:1) was used.

A negative electrode 14 obtained in the above was placed on the separator 13 in the positive electrode can 11. A stainless steel negative electrode can 16 furnished with a polypropylene gasket 15 at its periphery was placed at an opening of the positive electrode can 11. An opening end of the positive electrode can 11 was crimped at the periphery of the negative electrode can 16 with the gasket 15 interposed therebetween, and the opening of the positive electrode can 11 was sealed. At this time, a pitch was applied to portions where the positive electrode can 11 and the negative electrode can 16 closely contact the gasket 15. Coin batteries with a diameter of 6.8 mm and a thickness of 2.1 mm were thus obtained.

For the above negative electrode 14, the negative electrode active material electrochemically alloyed with lithium was used, by allowing the negative electrode active material to absorb lithium with the presence of an electrolyte.

In this Example, although polypropylene was used for a gasket material, other than polypropylene, in view of stability to the electrolyte and heat resistance, polyphenylene sulfide, polyether ketone, polyamide, polyimide, and liquid crystal polymer are used. These may be used singly, or may be used in combination. A filler such as an inorganic fiber may be added to the above polymer. Although a low-cost polypropylene is used usually, when reflow resistance is to be given to the batteries, polyphenylene sulfide, polyether ketone, polyimide, and liquid crystal polymer with a heat distortion temperature of 230° C. or more are used preferably.

In this Example, although a pitch was applied to portions of the gasket contacting the positive electrode can and the negative electrode can as a sealing material to improve the battery hermeticity, other than the pitch, an asphalt pitch, butyl rubber, and a fluorine oil may be used for the sealing material. In the case of a transparent sealing material, coloration may be given to clarify the presence or absence of the application. Also, instead of applying the sealing material to the gasket, a sealing material may be applied to portions of the positive electrode can and the negative electrode can contacting the gasket in advance.

### COMPARATIVE EXAMPLE 1

A polyamic acid solution (U-varnish A manufactured by Ube Industries, LTD., 20 wt % NMP solution) was used instead of the binder material solution in Example 1, and a weight ratio between the Ti—Si alloy, graphite, and polyamic acid in the negative electrode mixture was set to 100:20:10. Other than the above, coin batteries were made in the same manner as Example 1.

### COMPARATIVE EXAMPLE 2

An NMP solution in which 10 wt % of a polyacrylic acid powder (JURYMER AC-10 LHP manufactured by Nihon Junyaku Co., Ltd.) was dissolved was used instead of the binder material solution in Example 1, and the weight ratio between the Ti—Si alloy, graphite, and polyacrylic acid in the negative electrode mixture were set to 100:20:10. Other than the above, coin batteries were made in the same manner as Example 1.

### COMPARATIVE EXAMPLE 3

Coin batteries were prepared in the same manner as Example 1 except that graphite (SP-5030 manufactured by Nippon Graphite Industries, ltd.) was used as the negative electrode active material instead of the Ti—Si alloy, and without using a conductive material, a negative electrode mixture including graphite, polyamic acid, and polyacrylic acid with a ratio of 100:5:5 was used.

Following evaluations were carried out for the batteries of Example 1 and Comparative Examples 1 to 3 in the above.

(6) Battery Charge and Discharge Test

Charge and discharge cycle test for the coin batteries obtained in the above was carried out in a constant temperature chamber of 20° C., as described in below.

A cycle of charge and discharge was repeated 50 times in a battery voltage range of 2.0 to 3.3 V at a constant current of 0.02 CA. The ratio of a discharge capacity at the 50th cycle relative to a discharge capacity at the second cycle (hereinafter referred to as the initial capacity) was set as the cycle capacity retention rate. The more the cycle capacity retention rate approaches 100, the more the cycle characteristics are excellent.

Additionally, for battery low temperature characteristics, the above charge and discharge cycle test was carried out in a constant temperature chamber of −20° C. The ratio of the initial capacity at −20° C. relative to the initial capacity at 20° C. was obtained as the low temperature capacity retention rate. The more the low temperature capacity retention rate approaches 100, the more the low temperature characteristics are excellent.

(7) Heat Resistance Test for Negative Electrode

After each battery was charged, the batteries were disassembled to take out the negative electrode with the lithium absorbed, and a Differential Scanning Calorimetry (DSC measurement) was carried out for the negative electrode by using a differential scanning calorimeter (Thermo Plus DSC8230 manufactured by Rigaku Corporation). In the DSC measurement, about 5 mg of the negative electrode taken out was placed in a stainless steel sample container (resistance to pressure: 50 atmospheres), and heated from an ambient temperature to a temperature of 400° C. in static air at a rising speed of 10° C./min.

At this time, a temperature at the heat-generation peak attributed to the negative electrode is regarded as the heat-generation peak temperature. A higher peak temperature represents excellent heat resistance. The evaluation results are shown in Table 1.

TABLE 1

| | | | | | Low | | Heat- |
|---|---|---|---|---|---|---|---|
| | Negative | | | | Temperature | Cycle | generation |
| | Electrode | | | Initial | Capacity | Capacity | Peak |
| | Active | Conductive | | Capacity | Retention | Retention | temperature |
| | Material | Material | Binder | (mAh) | Rate (%) | Rate (%) | (° C.) |
| Ex. 1 | Ti—Si | Graphite | Polyimide + Polyacrylic | 6.5 | 83 | 94 | 310 |
| | alloy | | acid | | | | |
| Comp. | Ti—Si | Graphite | Polyimide | 6.5 | 35 | 94 | 310 |
| Ex. 1 | alloy | | | | | | |
| Comp. | Ti—Si | Graphite | Polyacrylic | 6.5 | 83 | 80 | 260 |
| Ex. 2 | alloy | | acid | | | | |
| Comp. | Graphite | None | Polymide + Polyacrylic | 0.5 | 81 | 90 | 250 |
| Ex. 3 | | | acid | | | | |

In the batteries of Example 1, in which a mixture of polyimide and polyacrylic acid was used for the negative electrode binder, low temperature characteristics improved greatly compared with the batteries of Comparative Example 1 in which polyimide alone was used for the negative electrode binder. This is probably because polyacrylic acid took precedence in making bond with the negative electrode active material and polyimide was prevented from being strongly bonded with the negative electrode active material, thereby retarding the decrease in the low temperature characteristics. Additionally, the cycle characteristics improved to the level equivalent to the case in Comparative Example 1, in which polyimide was used singly.

In the batteries of Example 1, in which the Ti—Si alloy was used for the negative electrode active material, the initial capacity increased compared with the batteries of Comparative Example 3 in which graphite was used for the negative electrode active material. Additionally, the negative electrode used for the batteries of Example 1 showed excellent heat resistance compared with the negative electrode used for the batteries in Comparative Example 3. This is probably because of a greater reactivity in the case when lithium was intercalated to graphite, compared with the case when lithium was intercalated to the Ti—Si alloy. When the Ti—Si alloy is used for the negative electrode active material, the Ti—Si alloy precedes graphite which is the conductive material, in the intercalation and deintercalation of lithium. Thus, only the Ti—Si alloy involves with the battery reaction as the active material without lithium being intercalated to and deintercalated from graphite. Therefore, heat resistance of the negative electrode is superior when the Ti—Si alloy is used for the negative electrode active material to the case where graphite is used.

Table 1 shows that different kind and mixing ratio of the binder cause different heat generation peak temperatures attributed to the negative electrode thermal decomposition (heat generation peak temperature in Table 1), and a negative electrode excellent in the heat resistance can be obtained when the binder including polyimide was used.

The above confirmed that, in the negative electrode, by using the Ti—Si alloy for the active material, polyimide and polyacrylic acid for the binder, and the carbon material for the conductive material, a high capacity non-aqueous electrolyte secondary battery with excellent low temperature characteristics, charge and discharge cycle characteristics, and heat resistance can be obtained.

### EXAMPLES 2 TO 5

In these Examples, the heating temperature of the negative electrode pellet containing polyamic acid as a precursor of polyimide, was examined in the case where polyimide and polyacrylic acid are used for the negative electrode binder.

Coin batteries were made in the same manner as Example 1, except that the heating temperature of the negative electrode pellet was changed to the temperatures shown in Table 2, and then evaluated. The evaluation results are shown in Table 2 along with the results for the batteries of Example 1.

TABLE 2

| | Negative | | | | | |
|---|---|---|---|---|---|---|
| | Electrode | | | | Low | |
| | Pellet | | | | Temperature | Cycle |
| | Heating | | | Initial | Capacity | Capacity |
| | Temperature | Polyacrylic | Imidization | Capacity | Retention | Retention |
| | (° C.) | Acid | Rate (%) | (mAh) | Rate (%) | Rate (%) |
| Ex. 2 | 150 | Remained | 20 | 6.5 | 85 | 84 |
| Ex. 3 | 200 | Remained | 80 | 6.5 | 85 | 90 |
| Ex. 1 | 250 | Remained | 98 | 6.5 | 83 | 94 |
| Ex. 4 | 300 | Remained | 100 | 6.5 | 80 | 94 |
| Ex. 5 | 400 | Mostly | 100 | 6.0 | 30 | 93 |
| | | Decomposed | | | | |

Since the negative electrode of Example 2 in which the heating temperature of the negative electrode pellet was 150° C. showed the low imidization rate, and polyamic acid was mostly not changed to polyimide, the cycle characteristics declined in the batteries using this negative electrode.

In the batteries of Examples 1 to 4, the amount of polyacrylic acid added at the time of the negative electrode preparation mostly remained, and excellent low temperature characteristics were obtained.

In the batteries of Example 5, the low temperature capacity retention rate declined. This is probably because in the negative electrode of Example 5, in which the heating temperature was 400° C., most part of polyacrylic acid was decomposed and the improvement effects of the low temperature characteristics due to the negative electrode including polyacrylic acid became less. The amount of polyacrylic acid in the negative electrode after heating was examined by the infrared spectroscopy (IR).

Since a high capacity non-aqueous electrolyte secondary battery with excellent low temperature characteristics, cycle characteristics, and heat resistance was obtained in especially in Examples 1, 3, and 4, the imidization rate of polyamic acid is preferably 80% or more, and the heating temperature of the negative electrode pellet is preferably 200 to 300° C.

### EXAMPLES 6 TO 10

In these Examples, the binder material (polyamic acid and polyacrylic acid) content in the negative electrode mixture was examined for the case when polyimide and polyacrylic acid were used for the binder in preparing a negative electrode.

Coin batteries were made in the same manner as Example 1, except that the binder material content per 100 parts by weight of the negative electrode active material in the negative electrode mixture was changed variously as shown in Table 3, without changing the mixing ratio of polyamic acid and polyacrylic acid in the binder material, and then evaluated.

The evaluation results are shown in Table 3 along with the evaluation results of Example 1.

TABLE 3

| | Binder Material Content | | |
|---|---|---|---|
| | in | | |
| | Negative Electrode | Initial | Cycle Capacity |
| | Mixture | Capacity | Retention Rate |
| | (parts by weight) | (mAh) | (%) |
| Ex. 6 | 0.2 | 6.5 | 86 |
| Ex. 7 | 0.5 | 6.5 | 93 |
| Ex. 8 | 5.0 | 6.5 | 94 |
| Ex. 1 | 10 | 6.5 | 94 |
| Ex. 9 | 30 | 6.4 | 94 |
| Ex. 10 | 40 | 6.0 | 94 |

In the batteries of Example 6, in which the binder material content in the negative electrode mixture is 0.2 parts by weight per 100 parts by weight of the negative electrode active material, cycle characteristics declined. This is probably because the small amount of the binder in the negative electrode reduced the effects of the binder.

On the other hand, in the batteries of Example 10, in which the binder material content in the negative electrode mixture is 40 parts by weight per 100 parts by weight of the negative electrode active material, the initial capacity declined. This is probably because the binder amount in the obtained negative electrode becomes excessive, and the negative electrode active material amount decreased relatively.

Since a high capacity non-aqueous electrolyte secondary battery with excellent cycle characteristics was obtained in Examples 1, and 7 to 9, the binder material content in the negative electrode mixture is preferably 0.5 to 30 parts by weight per 100 parts by weight of the negative electrode active material.

### EXAMPLES 11 TO 14 AND COMPARATIVE EXAMPLE 4

In preparation of the negative electrode, the polyamic acid content per 100 parts by weight of the binder material (polyamic acid and polyacrylic acid) in the negative electrode mixture was changed variously as shown in Table 4, without changing the binder material content in the negative electrode mixture. Other than the above, coin batteries were made in the same manner as Example 1, and evaluated. The evaluation results are shown in Table 4 along with the results of Example 1.

TABLE 4

| | Polyamic | | | |
|---|---|---|---|---|
| | Acid | Low | | |
| | Content | Temperature | Cycle | Heat |
| | in Binder | Capacity | Capacity | Generation |
| | Material | Retention | Retention | Peak |
| | (parts by | Rate | Rate | temperature |
| | weight) | (%) | (%) | (° C.) |
| Ex. 11 | 5.0 | 85 | 85 | 295 |
| Ex. 12 | 10 | 85 | 91 | 298 |
| Ex. 1 | 50 | 85 | 94 | 310 |
| Ex. 13 | 80 | 82 | 94 | 310 |
| Ex. 14 | 95 | 80 | 94 | 310 |
| Comp. | 100 | 50 | 95 | 310 |
| Ex. 4 | | | | |

In the batteries of Example 11, in which polyacrylic acid content in the binder material was 5.0 parts by weight per 100 parts by weight of the total binder material, cycle characteristics and low temperature characteristics declined. This is probably because the content of polyamic acid as a precursor of polyamide is small and the effects of polyimide became less.

On the other hand, in the batteries of Comparative Example 4, in which the polyamic acid content in the binder material is 100 parts by weight per 100 parts by weight of the binder material, low temperature characteristics decreased greatly. This is probably because the amount of polyacrylic acid does not exist for preceding polyimide in bonding with the Ti—Si alloy, and polyimide made strong bond with the Ti—Si alloy.

Since a non-aqueous electrolyte secondary battery with excellent low temperature characteristics and cycle characteristics was obtained in Examples 1 and 12 to 14, the polyamic acid content in the negative electrode mixture is preferably 10 to 95 parts by weight per 100 parts by weight of the binder material.

### EXAMPLES 15 TO 22

A transition metal M (M is Zr, Ni, Cu, Fe, Mo, Co, or Mn) powder (manufactured by Kojundo Chemical Lab. Co., Ltd., 99.99% purity, and particle size of below 20 μm) and a Si powder (manufactured by Kanto Chemical Co., Inc., 99.999% purity, and particle size of below 20 μm) were mixed so that the proportion of the Si phase, i.e., the phase A in the negative electrode active material particles is 30 wt %. The mixing weight ratios between the transition metal M and Si were Zr:Si=43.3:56.7, Ni:Si=35.8:64.2, Cu:Si=37.2:62.8, Fe:Si=34.9:65.1, Mo:Si=44.2:55.8, Co:Si=35.8:64.2, and Mn:Si=34.6:65.4.

The mixed powder was placed in a vibration mill container, and further stainless steel balls (diameter of 2 cm) were placed so that the balls occupied 70 volume % of the container capacity. After vaccuming the inside of the container, the inside of the container was replaced with Ar (manufactured by Nippon Sanso Corporation, and 99.999% purity) until the pressure of the inside of the container becomes 1 atmosphere. Afterwards, a mechanical alloying was carried out for 60 hours while applying a vibration of 60 Hz, to obtain a M-Si alloy.

As a result of carrying out an X-ray diffraction measurement for the obtained M-Si alloy powder, it was confirmed that a phase solely made of Si and a MSi₂ phase existed in the alloy particles. Also, as a result of observing the alloy material with a transmission electron microscope (TEM), the existence of a Si phase which is amorphous or having a crystal size of about 10 nm crystal, and a MSi₂ phase having a crystal size of about 15 to 20 nm was confirmed.

Then, a negative electrode mixture was obtained in the same manner as Example 1 except that a M-Si alloy powder or the above Si powder was used instead of the Ti—Si alloy powder. The weight ratio between the M-Si alloy powder or the above Si powder, a graphite powder, polyamic acid, and polyacrylic acid in the negative electrode mixture was set to 100:20:5.0:5.0.

Coin batteries were made in the same manner as Example 1 and evaluated. The evaluation results are shown in Table 5 along with the results of Example 1.

TABLE 5

| | | Low | |
|---|---|---|---|
| | | Temperature | Cycle |
| | | Capacity | Capacity |
| | Negative | Retention | Retention |
| | Electrode | Rate | Rate |
| | Active Material | (%) | (%) |
| Example 1 | Ti—Si alloy | 85 | 94 |
| Example 15 | Zr—Si alloy | 85 | 91 |
| Example 16 | Ni—Si alloy | 85 | 90 |
| Example 17 | Cu—Si alloy | 85 | 92 |
| Example 18 | Fe—Si alloy | 85 | 91 |
| Example 19 | Mo—Si alloy | 85 | 90 |
| Example 20 | Co—Si alloy | 85 | 86 |
| Example 21 | Mn—Si alloy | 85 | 85 |
| Example 22 | Si | 71 | 81 |

Excellent low temperature characteristics were obtained in the batteries of Examples 1 and 15 to 21. An oxide of the transition metal is formed on the negative electrode active material surface. Since a hydroxyl group (—OH) exists at the transition metal oxide surface, it forms a hydrogen bond with polyacrylic acid having a carboxyl group (—COOH). Accordingly, polyacrylic acid precedes polyimide in making bond with the M-Si alloy.

In the batteries of Examples 1 and 15 to 21, in which a Si alloy including a transition metal was used in the negative electrode active material, excellent cycle characteristics and low temperature characteristics were obtained compared with the batteries of Example 22 using Si solely.

Causes for the above results may be as follows. The main causes for the deterioration in cycle in the case of the negative electrode active material including Si is a decline in current collective ability in the negative electrode involved with charge and discharge. That is, due to expansion and contraction of the active material particles which occur upon lithium absorption and desorption, contact points decrease between the active material particles and the current collector, and between the active material particles to damage the electron conductive network of the negative electrode, thereby increasing the resistance of the negative electrode. However, such decline in the negative electrode current collective ability was retarded when the above Si alloy was used compared with the case in which matter composed solely of Si was used.

The non-aqueous electrolyte secondary battery of the present invention has a high capacity, and is excellent in cycle characteristics and low temperature characteristics, which makes it suitable for usage as a main power source for various electronic devices such as mobile phone and digital camera and a power source for memory backup.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode for a non-aqueous electrolyte secondary battery, comprising an active material including Si, a binder, and a conductive material,
wherein said binder comprises polyimide and polyacrylic acid, and
said conductive material comprises a carbon material.

2. The negative electrode for a non-aqueous electrolyte secondary battery in accordance with claim 1, wherein said polyimide is imidized polyamic acid.

3. The negative electrode for a non-aqueous electrolyte secondary battery in accordance with claim 2, wherein an imidization rate of said polyamic acid is 80% or more.

4. The negative electrode for a non-aqueous electrolyte secondary battery in accordance with claim 1,
wherein said negative electrode active material comprises a first phase including Si, and a second phase including a silicide of a transition metal; and
at least one of said first phase and said second phase is in at least one state of amorphous state and low-crystalline state.

5. The negative electrode for a non-aqueous electrolyte secondary battery in accordance with claim 4, wherein said transition metal is at least one selected from the group consisting of Ti, Zr, Ni, Cu, Fe, and Mo.

6. The negative electrode for a non-aqueous electrolyte secondary battery in accordance with claim 4, wherein said silicide of a transition metal is TiSi₂.

7. A non-aqueous electrolyte secondary battery comprising the negative electrode in accordance with claim 1, a positive electrode, a separator interposed between said positive electrode and said negative electrode, and a non-aqueous electrolyte.

8. A method for producing a negative electrode for a non-aqueous electrolyte secondary battery, the method comprising the steps of:
(1) mixing an active material including Si, a binder material solution including polyamic acid and polyacrylic acid, and a carbon material as a conductive material, and
heating and drying the mixture to obtain a negative electrode mixture; and
(2) pressure-molding said negative electrode mixture to obtain a pellet, and
heating said pellet to imidize said polyamic acid to obtain polyimide, thereby obtaining a negative electrode including polyimide and polyacrylic acid as a binder.

9. The method for producing a negative electrode for a non-aqueous electrolyte secondary battery in accordance with claim 8, wherein a heating temperature of said pellets in said step (2) is 200 to 300° C.

10. The method for producing a negative electrode for a non-aqueous electrolyte secondary battery in accordance with claim 8, wherein an imidization rate of said polyamic acid in said step (2) is 80% or more.

11. The method for producing a negative electrode for a non-aqueous electrolyte secondary battery in accordance with claim 8, wherein a total content of said polyamic acid and said polyacrylic acid in said negative electrode mixture is 0.5 to 30 parts by weight per 100 parts by weight of said active material.

12. The method for producing a negative electrode for a non-aqueous electrolyte secondary battery in accordance with claim 8, wherein said polyamic acid content in said negative electrode mixture is 10 to 95 parts by weight per 100 parts by weight of the total of said polyamic acid and said polyacrylic acid.
